(19) United States
(12) Patent Application Publication
(10) Pub. No.: US 2009/0318188 A1
(43) Pub. Date: Dec. 24, 2009

(54) Capacitor

(75) Inventors: Tomi Juhani Lintulahti, Tampere (FI); Samuli Untamo Wallius, Turku (FI); Mikko Aulis Perala, Tampere (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/214,572

(22) Filed: Jun. 19, 2008

(51) Int. Cl. H04M 1/00; H04N 5/222; H01G 9/00

(52) U.S. Cl. 455/556.1; 348/370; 361/500; 348/E05.022

(57) ABSTRACT

An apparatus including a housing; an anode extending into the housing; a cathode extending into the housing spaced from the anode; and a closure in an aperture of the housing. The closure includes electrically conductive material. The anode and cathode extend through the closure. The closure electrically connects the cathode to the housing.

### BACKGROUND OF THE INVENTION

1. Field of the Invention

The invention relates to an electrical device and, more particularly, to grounding in an electrical device.

2. Brief Description of Prior Developments

Xenon flash devices have been used for cameras in the past. A xenon flash module can have a 320V capacitor/capacitors for example. This kind of module is covered under a new European Union (EU) safety standard. One safety issue relates to grounding of the capacitor used with the flash. Using an extra soldering pin for a grounding-type of solution for the capacitor is not possible because of current manufacturing processes of capacitors.

### SUMMARY

The following summary is merely intended to be exemplary. The summary is not intended to limit the scope of the claimed invention.

In accordance with one aspect of the invention, an apparatus is provided comprising circuitry; a camera connected to the circuitry; and a flash connected to the circuitry. The flash comprises a flash lamp and a capacitor. The capacitor comprises a cathode electrically connected to a housing of the capacitor by an electrically conductive closure. The closure closes an aperture through the housing. The cathode is connected to ground through a conductor of the circuitry.

In accordance with another aspect of the invention, an apparatus is provided including a housing; an anode extending into the housing; a cathode extending into the housing spaced from the anode; and a closure in an aperture of the housing. The closure includes electrically conductive material. The anode and cathode extend through the closure. The closure electrically connects the cathode to the housing.

In accordance with another aspect of the invention, an apparatus is provided comprising a housing; an anode extending into the housing; a cathode extending into the housing spaced from the anode; a closure in an aperture of the housing, wherein the closure comprises electrically conductive material, wherein the anode and cathode extend through the closure; and an electrical insulator between the anode and the closure, wherein the insulator electrically insulates the anode from the closure. The closure is connected to the housing by a pressure joint in the aperture of the housing. The closure electrically connects the cathode to the housing.

In accordance with another aspect of the invention, a method is provided comprising providing an anode, a cathode and dielectric material through an aperture of a capacitor housing; and inserting a closure into the aperture of the capacitor housing, wherein the closure electrically connects the cathode to the capacitor housing.

In accordance with another aspect of the invention, a method is provided comprising providing a capacitor comprising a cathode electrically connected to a housing of the capacitor by a closure, wherein the closure is located in an aperture into the housing, and wherein the cathode extends pasts opposite side of the closure; and connecting the cathode to ground to thereby electrically connect the housing to ground.

### BRIEF DESCRIPTION OF THE DRAWINGS

The foregoing aspects and other features of the invention are explained in the following description, taken in connection with the accompanying drawings, wherein:

FIG. 1 is a block diagram of a device comprising features of the invention;

FIG. 2 is a diagram illustrating some of the components of the device shown in FIG. 1;

FIG. 3 is a perspective view of components of the flash shown in FIG. 2;

FIG. 4 is a cut away view of components of the capacitor shown in FIG. 3;

FIG. 5 is a block diagram illustrating steps of one aspect of the invention;

FIG. 6 is a block diagram illustrating steps of another aspect of the invention;

FIG. 7 is a partial cross sectional view of another embodiment of the invention;

FIG. 8 is a partial cross sectional view of another embodiment of the invention; and

FIG. 9 is a partial cross sectional view of another embodiment of the invention.

### DETAILED DESCRIPTION OF EMBODIMENT

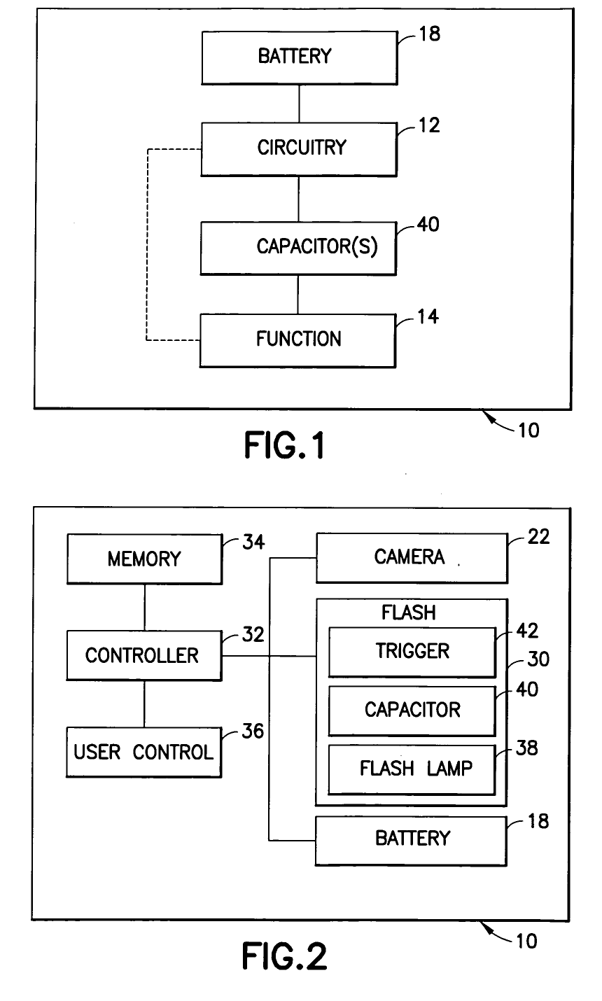

Referring to FIG. 1, there is shown a diagram of a device 10 incorporating features of the invention shown. Although the invention will be described with reference to the embodiments shown in the drawings, it should be understood that the invention can be embodied in many alternate forms of embodiments. In addition, any suitable size, shape or type of elements or materials could be used.

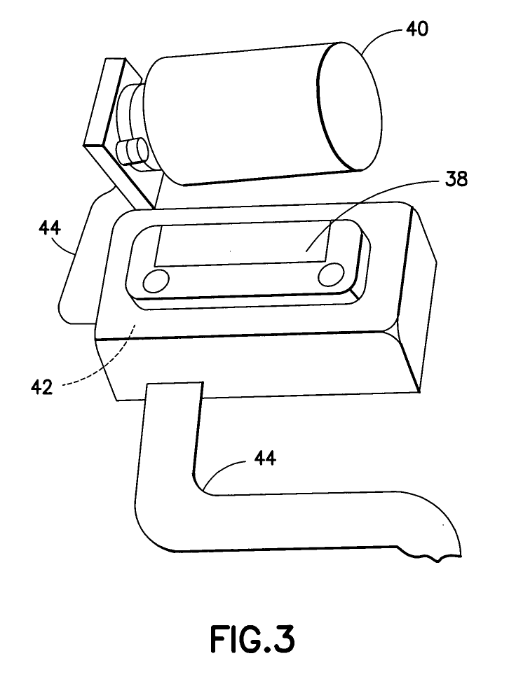

In one embodiment, the device 10 is an imaging device, such as a digital camera. Alternatively, the device 10 could be any suitable type of device having a capacitor as further understood from the description below. For example, in one embodiment the device 10 is a mobile telephone handset having a digital camera feature. The device 10 generally comprises a battery 18, circuitry 12, one or more capacitors 40, and a function 14. For the imaging device 10 in this embodiment, the function 14 comprises suitable hardware and perhaps software for taking a digital photograph. However, any suitable function which uses a capacitor could be provided. Referring also to FIG. 2, the function 14 can include a controller 32 and a memory 34. The device 10 can comprise a user control 36, such as a keypad or a touch screen for example, which is connected to the controller 32. In this embodiment the function 14 includes a camera 22 and a flash 30. The camera 22, flash 30 and battery 18 are connected to the controller 32. The controller 32 is configured, such as with software programming, to take a digital picture with the camera 22 and store the digital information in the memory 34. The controller 32 can also control actuation of the flash 30. In one type of embodiment, actuation of the flash 30 might be automatic when the camera 22 is used.

Referring also to FIG. 3, the flash 30 comprises a flash lamp 38, the capacitor(s) 40 and a trigger 42. The flash lamp 38 is a xenon flash lamp. However, any suitable flash lamp could be provided. In this embodiment, the circuitry 12 includes a flex cable 44 which electrically connects the capacitor 40 to the battery 18, electrically connects the capacitor 40 to the flash lamp 38, and electrically connects the trigger 42 to the controller 32, the capacitor 40 and the flash lamp 38. In alternate embodiments any suitable connection among the components could be provided.

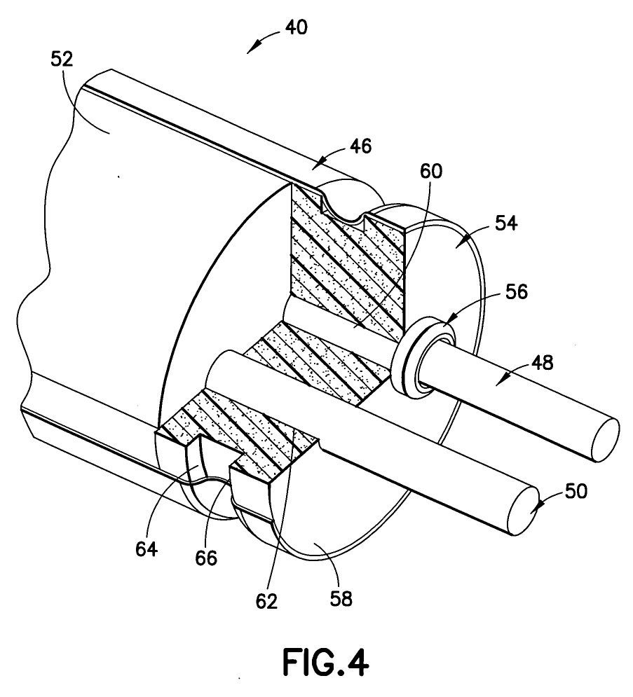

Referring also to FIG. 4, the capacitor 40 generally comprises a body or housing 46, an anode 48, a cathode 50, dielectric material 52, and a seal or closure 54. It should be noted that in some regions, use of “anode” and “cathode” are reversed. For example, in Japan “anode” might be considered a “cathode”, and visa versa. The capacitor 40 can be connected to the flex cable 44 with the anode 48 and cathode 50 being electrically, directly connected to conductors of the cable, such as by solder. The housing 46 is comprises of electrically conductive metal, such as in the form of a can. The housing 46 has an aperture 58 into the housing. The aperture forms an entry for the anode 48, cathode 50, and dielectric material 52 to be placed into the housing during manufacture of the capacitor. An suitable anode, cathode, and dielectric material could be used.

The closure 54 forms a seal to close the aperture 58 and retain the dielectric material and portions of the anode and cathode inside the housing 46. In this embodiment the closure 54 is provided as a one piece member comprised of electrically conductive material. In the embodiment shown the material is a resiliently deflectable polymer or rubber material. The closure has a general disk shape with two holes 60, 62 and an annular recess 64 along its outer side perimeter. The holes 60, 62 provide channels for the anode and cathode to pass through from the dielectric material to the exterior of the capacitor.

In this embodiment the capacitor also comprises an electrical insulator 56. The insulator 56 is provided between the anode 48 and the closure 54. The insulator 56 is located in the hole 60 and electrically insulates the anode 48 from the closure 54. In this embodiment, the insulator 56 has a general tube shape. However, in alternate embodiments any suitable shape or type of insulator could be provided.

A portion 66 of the housing 46 is deformed inward proximate the entrance aperture 58 into the annular recess 64. This locks the closure 54 in position in the aperture 58 to thereby close the aperture. This deformation creates a pressure joint between the closure 54 and the housing 46 which mechanically and electrically connects the closure with the housing. In an alternate embodiment the recess 64 might not be provided, such as if the portion 66 merely deforms the closure 54 inward without need for the recess 64.

Because the closure 54 is made of electrically conductive material, the closure 54 is able to directly connect the cathode 50 to the housing 46. Thus, when the cathode 50 is connected to the flex cable 44, the housing 46 can be automatically connected to ground through the closure 54, the cathode 50 and the flex cable 44.

In accordance with one aspect of the invention, an apparatus is provided such as a digital stand alone camera, or a multifunction device such as a mobile telephone handset, or a subassembly for a device, such as a camera module subassembly for example. The apparatus comprises circuitry 44, a camera 22 connected to the circuitry; and a flash 30 connected to the circuitry. The flash comprises a flash lamp 38 and a capacitor 40. The capacitor comprises a cathode 50 electrically connected to a housing 46 of the capacitor by an electrically conductive closure 54. The closure closes an aperture 58 through the housing. The cathode is connected to a conductor of the circuitry for connection to ground.

In accordance with one aspect of the invention, an apparatus 40 can be provided including a housing 46; an anode 48 extending into the housing; a cathode 50 extending into the housing spaced from the anode; and a closure 54 in an aperture of the housing. The closure includes electrically conductive material. The anode and cathode extend through the closure. The closure electrically connects the cathode to the housing.

In accordance with another aspect of the invention, an apparatus 40 is provided comprising a housing 46; an anode 48 extending into the housing; a cathode 50 extending into the housing spaced from the anode; a closure 54 in an aperture of the housing, wherein the closure comprises electrically conductive material, wherein the anode and cathode extend through the closure; and an electrical insulator 56 between the anode and the closure, wherein the insulator electrically insulates the anode from the closure. The closure is connected to the housing by a pressure joint 64/66 in the aperture of the housing. The closure electrically connects the cathode to the housing.

Referring also to FIG. 5, in accordance with another aspect of the invention, a method is provided comprising providing an anode, a cathode and dielectric material through an aperture of a capacitor housing as indicated by block 68; and inserting a closure into the aperture of the capacitor housing and indicated by block 70, wherein the closure electrically connects the cathode to the capacitor housing.

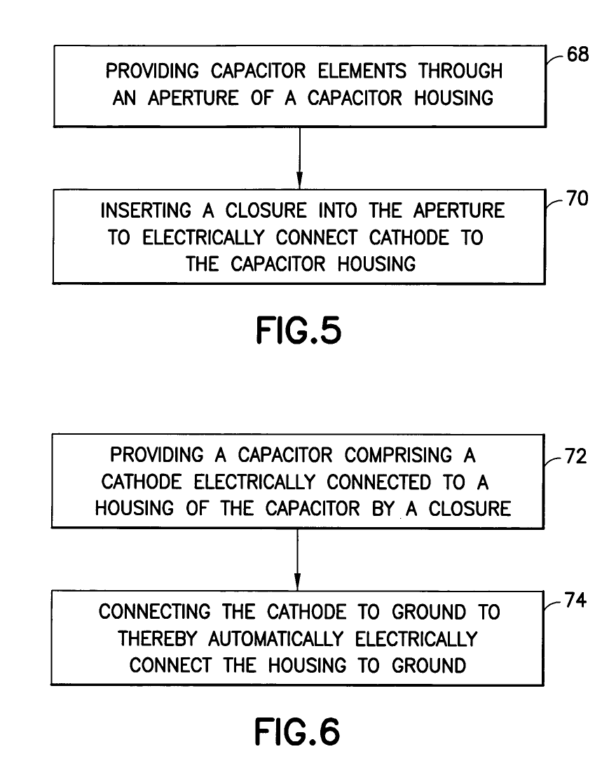

Referring also to FIG. 6, in accordance with another aspect of the invention, a method is provided comprising providing a capacitor comprising a cathode electrically connected to a housing of the capacitor by a closure as indicated by block 72, wherein the closure is located in an aperture into the housing, and wherein the cathode extends pasts opposite side of the closure; and connecting the cathode to ground to thereby automatically electrically connect the housing to ground as indicated by block 74.

As noted above, normal grounding methods used for a capacitor for a flash lamp include conductive tapes, conductive adhesives or mechanical parts, such as sockets. These methods require time on an assembly line, as well as not always being reliable.

The invention can use a conductive rubber or polymer seal for the capacitor to ensure good grounding of the capacitor body to a conductor via the cathode pin. The invention can provide better grounding, lower assembly time, and no need to change the majority of current manufacturing steps of the component. A novel feature of the invention can include usage of conductive rubber to seal the capacitor, or a similar component and, thus, ensuring good grounding of the body of the component. The invention can comprise a new structure, method and apparatus of an improved shielding of a solderable component.

With the invention a manufacturer can change a conventional capacitor rubber seal (made of electrically insulating material) to a conductive material which can then be used to make electrical contact between the capacitor body and the cathode pin. This can be used to fulfill new safety requirements noted above. Also, adding one insulator part 56 can keep the anode electrically separated from the capacitor body. In one type of embodiment, electrically separating the anode from the capacitor body can be done by having the rubber seal being only partially conductive. When the capacitor is manufactured, the housing body can be punched at 66 to keep the seal in place. With this punch, the capacitor body can make a permanent electrical contact with the conductive rubber. The electrically conductive rubber will make a connection between the cathode wire and the capacitor ground body, and then no other groundings are needed to fulfill the safety standard noted above. The rest of the assembly process is totally the same as capacitor manufactures currently use.

Advantages include a low cost to manufacture compared to current methods. There is no need for any extra space in the device. Reliability is increased and much more easy to handle in the assembly process. Grounding is now part of the capacitor and is done by the capacitor manufacturer instead of a flash module manufacturer. This also allows a possibility to have similar grounding between all xenon suppliers instead of every xenon module supplier having its own solution as currently done. In addition, if used in a mobile telephone handset (having a camera), then phone-level safety testing is not needed.

During capacitor assembly, the sealing rubber will be assembled on top of the capacitor for sealing it. After assembly, the metal body can be punched toward sealing the rubber tight to fix the rubber in place. By changing the rubber material to conductive material, it is possible to contact ground to cathode without any extra part. Also, use of the invention with current assembly methods will make electrical ground contact automatically. No extra contact or assembly is needed.

An electrical insulator part can be used to protect the anode wire. It is also possible to make the rubber-part only partially electrically conductive, so then this insulator part is not needed. Using different material when making capacitor shielding will fulfill the new standard, and also it will not need any tooling modification or new assembly methods. It should be noted that, although the invention was described above with reference to a capacitor used with a camera flash, the capacitor could be used in any suitable type of electrical device. In addition, features of the invention could be used in an electrical device which is not a capacitor.

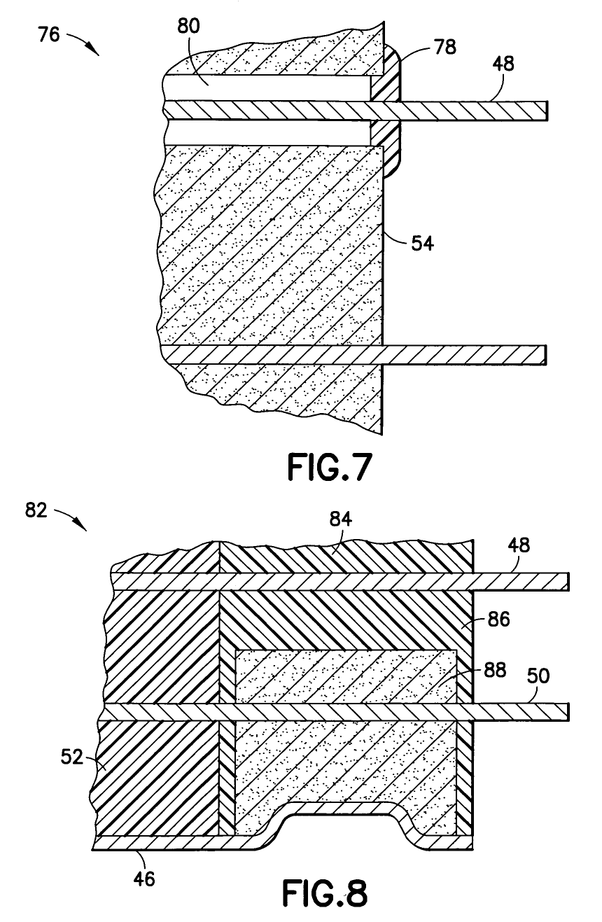

Referring also to FIG. 7, one alternate embodiment of the invention is shown. In this embodiment the capacitor 76 has an enlarged hole 60 and a spacer 78. Thus, a gap 80 is formed to electrically insulate the anode 48 from the closure 54. The gap 80 can comprise air or a portion of the dielectric material 52.

Referring also to FIG. 8, another alternate embodiment of the invention is shown. In this embodiment the capacitor 82 comprises a closure 84 comprised of a first member 86 overmolded onto a second member 88. The first member 86 can be comprised of electrically insulating material and the second member 88 can be comprised of electrically conductive material.

The first and second members 86, 88 each preferably comprise resiliently deformable polymer material. Thus, the housing 46 can be inwardly deformed or stamped to fixedly mount the closure 84 in the aperture into the housing. However, in an alternate embodiment the second member 88 might not comprise a resiliently deformable polymer material. The second member 88 electrically connects the housing 46 to the cathode 50. The first member 86 electrically insulates the anode 48 from the cathode and the housing.

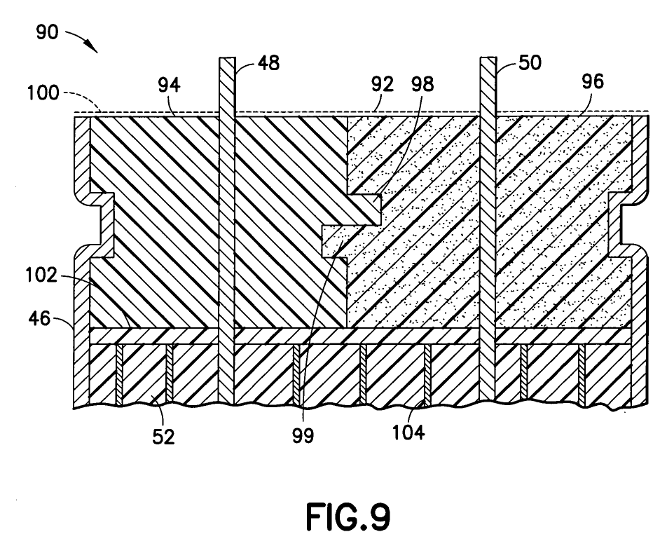

Referring also to FIG. 9, another alternate embodiment of the invention is shown. In this embodiment the capacitor 90 comprises a closure 92 comprised of a first member 94 and a second member 96. The first and second members 94, 96 comprising interlocking sections 98, 99. The first member 94 can be comprised of electrically insulating material and the second member 96 can be comprised of electrically conductive material. The first and second members 94, 96 each preferably comprise resiliently deformable polymer material. Thus, the housing 46 can be inwardly deformed or stamped to fixedly mount the closure 92 in the aperture into the housing. However, the capacitor 90 could alternatively or additionally comprise a cap 100, such as epoxy for example to retain the closure 92 in the aperture. The second member 96 electrically connects the housing 46 to the cathode 50. The first member 94 electrically insulates the anode 48 from the cathode and the housing. A dielectric member 102, such as a washer, could be provided to electrically insulate ends of the anode plate 104 from the electrically conductive material of the closure.

One way to fulfill the safety standard noted above is to ground the capacitor body to the ground of the flash device made by a xenon module supplier. However possible solutions of grounding the capacitor body to the ground of the flash device made by a xenon module supplier are not very reliability or they will need extra tooling in production. Also, they would be costly and make production very slow. The invention, on the other hand, can provide the advantage of grounding a capacitor body to a shielding ground reliably and cost efficiently. Possible solutions of grounding the capacitor body to the ground of the flash device made by a xenon module supplier are also not particularly suitable in mass production and they need extra work and cost. Also they are not reliably enough.

Different ways to make contact between a capacitor body to the ground of the flash device made by a xenon module supplier include use of conductive tapes, conductive adhesives or mechanical parts. They all need separate assembly processes when making a flash module, and also they need extra parts, toolings and make an assembly line very slow.

For conductive adhesive the capacitor ground body could be connected to a flex cable using conductive adhesive. Problems, however, include curing time is very long (maybe hours) which makes the assembly process very slow, extra adhesive is needed and extra dispensers are needed, extra features for the flex cable is needed (some opening area to flex), and the increased size needs some controlling during the process.

For conductive tape, glue could be used between a flex cable and/or a cathode pin and the capacitor body. Problems include extra parts are needed and tape cutting tools are needed, an extra assembly process is needed, there are reliability problems in that the tape might be drop out from contacts points if adhesive is not good enough, and increased size of the final product.

For a mechanical contact between the flex cable and the capacitor, an extra mechanical part could be used to make contact between the capacitor and the grounding point. Problems include extra parts are needed and expensive cutting tools are needed, and an extra assembly process is needed, there are reliability problems with the capacitor tolerances varying a lot, so very good spring contacts are needed, and this increases the size of the final product.

For a mechanical contact between phone mechanics and the capacitor, an extra mechanical part could be used to make contact between the capacitor and the grounding point. Problems include extra parts are needed and expensive cutting tools are needed, an extra assembly process is needed, there are reliability problems with the capacitor tolerances varying a lot, so very good spring contacts are needed, this increases the size of the final product, and the whole device (such as a mobile telephone handset) needs to be tested relative to safety standards.

The invention can be used to provide a ground when the capacitor is manufactured. Thus, there is no need for the xenon module supplier to perform an extra manufacturing process to provide a grounding connection for a capacitor. The capacitor is automatically grounded when the cathode is connected to the flex cable. Thus, all the potential problems noted above can be overcome by use of the invention.

With the invention, the invention can be provided by a camera module manufacturer or a flash module manufacturer to a device manufacturer, such as a manufacturer of a mobile telephone handset for example. The invention could be used in suitable multifunction devices having a camera function with a flash. The invention can also be used in a stand alone digital camera rather than a multifunction device. The invention can also be used in a device other than for a camera function. The invention could be provided as a flash module configured to be inserted into a device as a single subassembly.

It should be understood that the foregoing description is only illustrative of the invention. Various alternatives and modifications can be devised by those skilled in the art without departing from the invention. For example, features recited in the various dependent claims could be combined with each other in any suitable combination(s). In addition, features from different embodiments described above could be selectively combined. Accordingly, the invention is intended to embrace all such alternatives, modifications and variances which fall within the scope of the appended claims.

What is claimed is:

1. An apparatus comprising:
circuitry;
a camera connected to the circuitry; and
a flash connected to the circuitry, wherein the flash comprises a flash lamp and a capacitor, wherein the capacitor comprises a cathode electrically connected to a housing of the capacitor by an electrically conductive closure, wherein the closure closes an aperture through the housing, and wherein the cathode is connected to a conductor of the circuitry for connection to ground.

2. An apparatus as in claim 1 wherein the apparatus comprises a flash module configured to be inserted into a device as a single subassembly.

3. An apparatus as in claim 1 wherein the apparatus comprises a mobile telephone handset.

4. An apparatus as in claim 1 wherein the apparatus comprises a digital camera.

5. An apparatus as in claim 1 wherein an anode and the cathode of the capacitor extend through holes of the closure.

6. An apparatus as in claim 1 wherein the housing is comprised of electrically conductive metal, and wherein the closure is directly connected to the housing by a pressure joint.

7. An apparatus as in claim 1 wherein the closure has a general disk shape with holes therethrough and an annular recess around a side of the general disk shape.

8. An apparatus as in claim 1 further comprising an electrical insulator between an anode of the capacitor and the closure to electrically insulate the anode from the closure.

9. An apparatus as in claim 8 wherein the electrical insulator comprises a general tube shape.

10. An apparatus as in claim 1 wherein the electrically conductive material of the closure comprises a resiliently deformable polymer material.

11. An apparatus as in claim 1 wherein an anode of the capacitor is electrically insulated from the closure.

12. An apparatus as in claim 1 wherein the closure comprises a first section having the electrically conductive material and a second section having electrically insulating, resiliently deformable material.

13. An apparatus comprising:
a housing;
an anode extending into the housing;
a cathode extending into the housing spaced from the anode;
a closure in an aperture of the housing, wherein the closure comprises electrically conductive material, wherein the anode and cathode extend through the closure; and
an electrical insulator between the anode and the closure, wherein the insulator electrically insulates the anode from the closure,
wherein the closure is connected to the housing by a pressure joint in the aperture of the housing, and wherein the closure electrically connects the cathode to the housing.

14. An apparatus as in claim 13 wherein the housing is comprised of electrically conductive metal, and wherein the closure is directly connected to the housing by the pressure joint.

15. An apparatus as in claim 13 wherein the closure has a general disk shape with two holes therethrough and an annular recess around a side of the general disk shape at the pressure joint.

16. An apparatus as in claim 13 further comprising electrically insulating material inside the housing directly between the anode and the cathode to form a capacitor.

17. An apparatus as in claim 16 wherein the closure comprises means for grounding the housing to another component through the cathode.

18. An apparatus as in claim 13 wherein the electrical insulator comprises a general tube shape.

19. An apparatus as in claim 13 wherein the electrically conductive material of the closure comprises a resiliently deformable polymer material.

20. An apparatus as in claim 13 wherein the anode is electrically insulated from the closure.

21. An apparatus as in claim 13 wherein the closure comprises a first section having the electrically conductive material and a second section having electrically insulating, resiliently deformable material.

22. An apparatus as in claim 13 wherein the closure forms a seal with the housing and the cathode at the aperture.

23. An apparatus comprising:
a housing;
an anode extending into the housing;
a cathode extending into the housing spaced from the anode; and
a closure in an aperture of the housing, wherein the closure comprises electrically conductive material, wherein the anode and cathode extend through the closure, and wherein the closure electrically connects the cathode to the housing.

24. An apparatus as in claim 23 wherein the housing is comprised of electrically conductive metal, and wherein the closure is directly connected to the housing by a pressure joint.

25. An apparatus as in claim 23 wherein the closure has a general disk shape with two holes therethrough and an annular recess around a side of the general disk shape.

26. An apparatus as in claim 23 further comprising electrically insulating material inside the housing directly between the anode and the cathode to form a capacitor.

27. An apparatus as in claim 26 wherein the closure comprises means for grounding the housing to another component through the cathode.

28. An apparatus as in claim 23 further comprising an electrical insulator between the anode and the closure to electrically insulate the anode from the closure.

29. An apparatus as in claim 28 wherein the electrical insulator comprises a general tube shape.

30. An apparatus as in claim 23 wherein the electrically conductive material of the closure comprises a resiliently deformable polymer material.

31. An apparatus as in claim 23 wherein the anode is electrically insulated from the closure.

32. An apparatus as in claim 23 wherein the closure comprises a first section having the electrically conductive material and a second section having electrically insulating, resiliently deformable material.

33. An apparatus as in claim 23 wherein the closure forms a seal with the housing and the cathode at the aperture.

34. A camera flash device comprising:
a flash lamp; and
an apparatus as in claim 23 connected to an input of the flash lamp.

35. A method comprising:
providing an anode, a cathode and dielectric material through an aperture of a capacitor housing; and
inserting a closure into the aperture of the capacitor housing, wherein the closure electrically connects the cathode to the capacitor housing.

36. A method as in claim 35 further comprising deforming the housing proximate the aperture to form a pressure joint with the closure, wherein the pressure joint electrically and mechanically connects the closure with the housing.

37. A method as in claim 35 further comprising locating an electrical insulator between the anode and the closure to electrically insulate the anode from the closure.

38. A method as in claim 35 wherein the closure comprises a general disk shape with two holes having the anode and cathode extend through the two holes, wherein inserting the closure comprises position the closure into the aperture and mechanically and electrically connecting an outer perimeter side the general disk shape to an inside surface of the housing.

39. A method comprising:
providing a capacitor comprising a cathode electrically connected to a housing of the capacitor by a closure, wherein the closure is located in an aperture into the housing, and wherein the cathode extends pasts opposite side of the closure; and
connecting the cathode to ground to thereby electrically connect the housing to ground.

40. A method as in claim 39 wherein connecting the cathode to the ground is the sole electrical connection of the capacitor to ground.
